(19) United States
(12) Patent Application Publication
(10) Pub. No.: US 2016/0142935 A1
(43) Pub. Date: May 19, 2016

(54) RAN USER-PLANE CONGESTION MANAGEMENT

(71) Applicant: NOKIA SOLUTIONS AND NETWORKS OY, Espoo (FI)

(72) Inventors: Martin OETTL, Weilheim (DE); Rainer LIEBHART, Munich (DE); Thomas THEIMER, Baierbrunn (DE)

(21) Appl. No.: 14/901,386

(22) PCT Filed: Jun. 28, 2013
(86) PCT No.: PCT/EP2013/063583

§ 371 Date: Dec. 28, 2015

(51) Int. Cl. H04W 28/02; H04L 12/859

(52) U.S. Cl. CPC H04W 28/0289; H04L 47/2475; H04W 28/0252

(57) ABSTRACT

There are provided measures for improving/enhancing RAN user-plane congestion management. Such measures exemplarily comprise detecting a congestion indication for at least one bearer, which indicates user-plane congestion for the at least one bearer in a radio access network, deciding on activation of application detection for the at least one bearer on the basis of the detested congestion indication, and activating application detection for the at least one bearer upon an activation decision.

### FIELD

The present invention relates to RAN user-plane congestion management. More specifically, the present invention exemplarily relates to measures (including methods, apparatuses and computer program products) for improving/enhancing management of user-plane congestion in a radio access network.

### BACKGROUND

Current cellular communication systems according to 3GPP specifications are typically based on the Evolved Packet System (EPS) which provides a new radio interface and new core network functions for broadband wireless data access. The EPS radio interface consists of a network access via E-UTRAN, which is provided in addition to the network accesses via UTRAN and GERAN. The EPS core network functions include the Mobility Management Entity (MME), the Packet Data Network Gateway (PGW) and the Serving Gateway (SGW). Basically, a common core network (in the packet domain) is used for all radio access networks including E-UTRAN, UTRRAN and GERAN.

FIG. 1 shows a schematic diagram illustrating the EPS architecture according to 3GPP TS 23.401, which represents an example of a communication system architecture, in which exemplary embodiments of the present invention (as described below) are applicable. In such architecture, the PGW and the HPLM PGW constitute gateway entities of the core network, which implement IP access to a home/visited PDN.

The GPRS architecture, which is the predecessor of the EPS architecture, represents another communication system architecture, in which exemplary embodiments of the present invention (as described below) are applicable. Therein, the GGSN constitutes a gateway entity of the core network, which implements IP access to a PDN.

In any one of the different radio access networks, RAN user-plane congestion (or overload) may occur. Namely, RAN user-plane congestion occurs when the demand for RAN resources exceeds the available RAN capacity to deliver the user data for a period of time. RAN user-plane congestion leads, for example, to packet drops or delays, and may or may not result in degraded end-user experience. RAN user-plane congestion includes user plane congestion that occurs over the air interface (e.g. LTE-Uu), in the radio node (e.g. eNB) and/or over the backhaul interface between RAN and CN (e.g. S1-U).

In 3GPP there is an ongoing study which defines system enhancements for user-plane congestion management, referred to as UPCON (System Enhancements for User-Plane Congestion Management). The normative requirements are defined in 3GPP TS 22.101, and the ongoing study results are captured in 3GPP TR 23.705. Enhancement options under discussion include congestion feedback from the RAN towards the CN and CN-based congestion mitigation including various mitigation measures such as differentiated QoS/QoE.

In this regard, application-based traffic management is one option to control the impact of RAN user-plane congestion to ongoing services, and to ensure that important applications or application flows can still be served by way of traffic prioritization. Application-based traffic management requires application detection in the core network to inspect and classify traffic/packets, identify the corresponding application or application flow and thus enable application-specific treatment also in the radio access network.

To ensure most appropriate application-based traffic management, it is presently presumed that all traffic passing the core network (from RAN towards PDN, or vice versa), i.e. a gateway entity thereof, is to be permanently detected all the time. This however requires a substantial amount of processing resources to inspect and classify all data traffic/packets, which leads to increasing cost and power consumption of the user-plane handling entities in the core network. Hence, present solutions for RAN user-plane congestion management with application-based traffic management are quite inefficient, especially in situations of low overall traffic load and an associated low likelihood of the occurrence of RAN user-plane congestion.

Accordingly, there is a demand for improving/enhancing management of user-plane congestion in a radio access network, i.e. RAN user-plane congestion management.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising detecting a congestion indication for at least one bearer, which indicates user-plane congestion for the at least one bearer in a radio access network, deciding on activation of application detection for the at least one bearer on the basis of the detected congestion indication, and activating application detection for the at least one bearer upon an activation decision.

According to an exemplary aspect of the present invention, there is provided an apparatus comprising an interface configured to communicate with at least another apparatus, a memory configured to store computer program code, and a processor configured to cause the apparatus to perform: detecting a congestion indication for at least one bearer, which indicates user-plane congestion for the at least one bearer in a radio access network, deciding on activation of application detection for the at least one bearer on the basis of the detected congestion indication, and activating application detection for the at least one bearer upon an activation decision.

According to an exemplary aspect of the present invention, there is provided an apparatus comprising means for detecting a congestion indication for at least one bearer, which indicates user-plane congestion for the at least one bearer in a radio access network, means for deciding on activation of application detection for the at least one bearer on the basis of the detected congestion indication, and means for activating application detection for the at least one bearer upon an activation decision.

According to an exemplary aspect of the present invention, there is provided a computer program product comprising computer-executable computer program code which, when the program code is executed (or run) on a computer or the program is run on a computer (e.g. a computer of an apparatus according to any one of the aforementioned apparatus-related exemplary aspects of the present invention), is configured to cause the computer to carry out the method according to the aforementioned method-related exemplary aspect of the present invention.

The computer program product may comprise or may be embodied as a (tangible) computer-readable (storage) medium or the like, on which the computer-executable computer program code is stored, and/or the program is directly loadable into an internal memory of the computer or a processor thereof.

Further developments and/or modifications of the aforementioned exemplary aspects of the present invention are set out in the following.

By way of exemplary embodiments of the present invention, there is provided an improved/enhanced management of user-plane congestion in a radio access network, i.e. RAN user-plane congestion management.

### BRIEF DESCRIPTION OF THE DRAWINGS

In the following, the present invention will be described in greater detail by way of non-limiting examples with reference to the accompanying drawings, in which

FIG. 1 shows a schematic diagram illustrating an example of a communication system architecture, in which exemplary embodiments of the present invention are applicable,

FIG. 2 shows a schematic diagram illustrating an overview of RAN user-plane congestion management according to exemplary embodiments of the present invention,

FIG. 3 shows a flowchart illustrating a first example of a method according to exemplary embodiments of the present invention,

FIG. 4 shows a flowchart illustrating a second example of a method according to exemplary embodiments of the present invention,

FIG. 5 shows a flowchart illustrating a third example of a method according to exemplary embodiments of the present invention,

FIG. 6 shows a flowchart illustrating a fourth example of a method according to exemplary embodiments of the present invention, and

FIG. 7 shows a schematic diagram illustrating an exemplary structure of apparatuses according to exemplary embodiments of the present invention.

### DETAILED DESCRIPTION OF DRAWINGS AND EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, for explaining applicability of thus described exemplary embodiments in an illustrative manner, an EPS/GPRS system is used as a non-limiting example of a network system. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

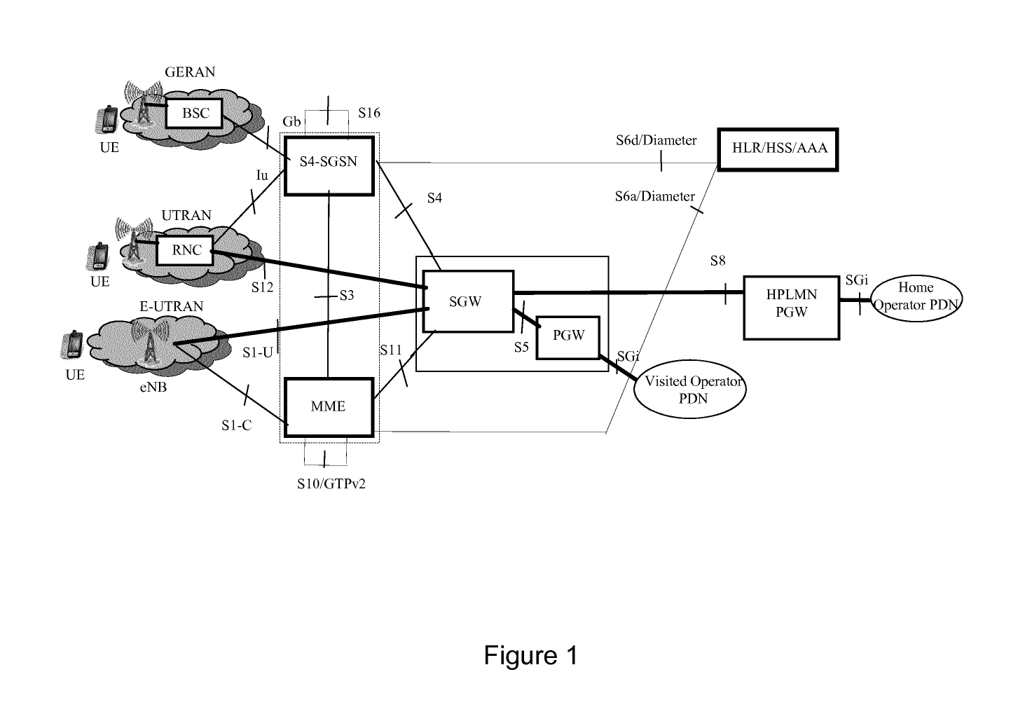

In particular, the present invention and its embodiments may be applicable in any cellular communication system and/or system deployment in which RAN user-plane congestion may occur and is intended to be managed and/or mitigated. For example, exemplary embodiments of the present invention are applicable in the EPS architecture according to FIG. 1.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to exemplary embodiments of the present invention, in general terms, there are provided measures and mechanisms for (improving/enhancing) management of user-plane congestion in a radio access network, i.e. RAN user-plane congestion management. Herein, when reference is made to congestion, this could equally be referred to as overload.

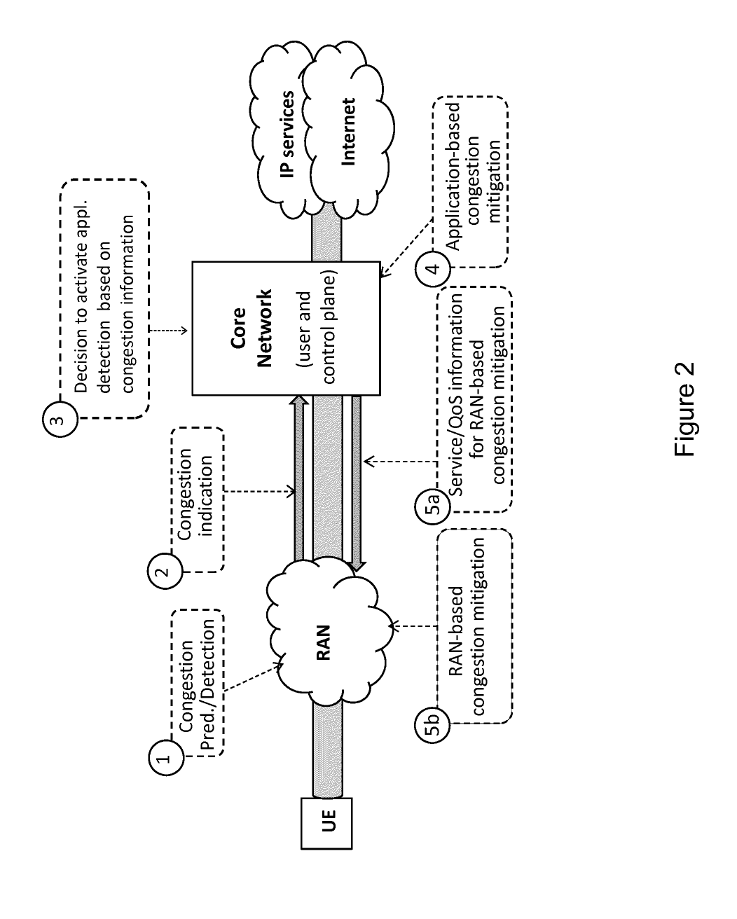

FIG. 2 shows a schematic diagram illustrating an overview of RAN user-plane congestion management according to exemplary embodiments of the present invention.

In the illustration of FIG. 2, the RAN may be implemented by way of any radio access network, such as E-UTRAN, UTRAN and/or GERAN, or element/entity thereof, such as eNB, RNC and/or BSC. The core network may be implemented by way of any core network, such as EPS CN, or element/entity thereof, such as PGW, HPLMN PGW and/or GGSN.

As shown in FIG. 2, a solution for RAN user-plane congestion management according to exemplary embodiments of the present invention comprises the following operations and procedures.

In a first step, the RAN performs user-plane congestion prediction and/or detection, e.g. on the radio interface (e.g. LTE-Uu in case of E-UTRAN). Such congestion prediction and/or detection may be effected for all (conceivable) bearers which may be (desired to be) subjected to RAN user-plane congestion mitigation and/or management.

In a second step, when congestion is predicted and/or detected for at least one bearer, the RAN sends a congestion indication, i.e. a RAN user-plane congestion indication, for the at least one bearer to the CN. Such congestion indication may be referred to as a bearer-specific congestion indication (possibly including relevant congestion information such as severity level of congestion, etc.). The (bearer-specific) congestion indication may refer to (congestion with respect to) a single bearer or multiple bearers, and the thus indicated congestion can be mapped to the respective bearer, i.e. in such a way that each affected bearer can be identified in terms of its congestion. This does not limit the technique or granularity of providing congestion feedback in any way (i.e. there is no requirement to send a separate congestion indication per each affected bearer) as long as congestion is somehow indicated for each affected bearer. Namely, a congestion indication can be sent per each affected bearer, a congestion indication can be sent per each sub-/set of affected bearers, and/or a congestion indication can be sent for all affected bearers. Irrespective of its granularity, the congestion indication may be transported in any conceivable manner. For example, the congestion indication may be sent inband via the user plane, e.g. using a new GTP-U header or any other inband header, or the congestion indication may be sent via any other feedback channel as well, e.g. using the control plane.

In a third step, when the congestion indication is received, i.e. detected, the CN makes a decision on the activation of application detection for the at least one bearer referred to in the congestion indication based thereon. Such application detection may be referred to as bearer-specific application detection, and may refer a single bearer or multiple bearers, such that the thus performed operation can be mapped to the respective bearer, i.e. in such a way that each affected bearer can be handled in terms of an application or application flow. That is, similar explanations in terms of different potential levels of granularity as described above for the congestion indication also apply for the application detection accordingly. Herein, when reference is made to application detection, such reference is intended to equally refer to application detection and/or application monitoring in similar measure, as the case may be. Note that it may be necessary to activate application detection (and monitoring) at relatively low congestion levels, to be able to achieve reliable application detection when the actual congestion mitigation is enabled (typically at higher congestion levels). Accordingly, the activation decision (i.e. a related threshold, parameter, criterion, etc.) may be arbitrary configured/set as necessary/desired.

In a fourth step, when an affirmative decision on activation is made, the CN activates the application detection for the at least one bearer. Application detection may then start to identify at least one application or application flow for the at least one bearer. Further, on the basis of the application detection, application-based congestion mitigation is performed. In this regard, traffic/packets may be inspected and classified according to usage of an application or application flow, and a specific QoS/QoE may be assigned to each application or application flow, which may be based on operator policies and user subscription data, while a severity level of the congestion may also be taken into account, for example. Depending on the type of mitigation measure, QoS/QoE control/adjustment may be effected through traffic prioritization, traffic reduction or traffic limitation based on the congestion indication (possibly relevant congestion information such as severity level of congestion, etc.). Thereby, differentiated QoS/QoE on application/application flow basis may be achieved. In this regard, both in-bearer QoS/QoE solutions and bearer-based QoS/QoE solutions in the RAN may be appropriately managed/handled.

Similar to the above, when the congestion indication is received and an affirmative decision on activation is made, the CN may also activate QoE monitoring. Herein, when reference is made to application detection, such reference is intended to equally refer to application detection and/or application quality (QoE) monitoring in similar measure, as the case may be. Such QoE monitoring can be integrated into/with the aforementioned application detection in a single entity or located in a separate monitoring function/entity e.g. on the Gi interface (between the packet-switched domain and an external packet data network). The activation of QoE monitoring in response to the congestion indication from the RAN can allow the network operator to explicitly monitor the user experience during user-plane congestion, and the effectiveness of the congestion mitigation measures taken in response to the congestion indication from the RAN can be improved accordingly. The QoE monitoring can be performed on application-level or on lower layers in the networking protocol stack.

In a fifth step, measures for RAN-based congestion mitigation are performed. Namely, RAN-based congestion mitigation is applied based on the QoS/QoE levels assigned by the core network. In step 5a, optional service/QoS/QoE information may be sent to the RAN to enable traffic differentiation in the RAN based on existing QoS/QoE measures. In step 5b, optional RAN-based congestion mitigation (e.g. traffic prioritization, scheduling) may be performed in the RAN.

According to exemplary embodiments of the present invention, the above-described RAN user-plane congestion management at the core network, i.e. the fourth and fifth steps according to FIG. 2, may be implemented in or by DPI functionality. Such DPI functionality may be implemented e.g. as an integrated function inside the gateway entity (i.e. PGW, GGSN, etc.) or in a standalone TDF entity. In case a standalone TDF entity is used, the gateway entity (i.e. PGW, GGSN, etc.) receiving the congestion indication forwards the congestion indication to the external TDF entity (either via PCRF or directly in user plane packets). Accordingly, the RAN user-plane congestion management according to exemplary embodiments of the present invention may be implemented in a PCC architecture including DPI functionality in TDF and/or PCEF (enhanced with ADC rules), e.g. according to 3GPP TS 23.203. Such PCC architecture may extend the architecture of an IP-CAN, where the PCEF is a functional element in the gateway entity implementing the IP access to the PDN.

In such implementation, DPI resources may be assigned dynamically to (congested) bearers (for traffic passing the core network in downlink and/or uplink direction) based on the congestion indication from the RAN. The assignment may be removed when the congestion indication has been cleared or after some pre-defined time (as explained below). Thus, multiple bearers can dynamically share a pool of DPI resources, which would otherwise be dedicated to specific bearers. This has the benefit of (possibly even significantly) reducing the amount of required DPI resources and increasing PDN gateway capacity accordingly. This is particularly efficient, as the DPI functionality and its resources are often a limiting factor for the user-plane traffic handling capacity of a gateway entity.

In a similar way, QoE monitoring resources may be assigned to congested bearers dynamically, and thus shared effectively, on the basis of the congestion indication from the RAN. In this regard, similar measures are applicable and similar effects are achievable, as described above for DPI resources.

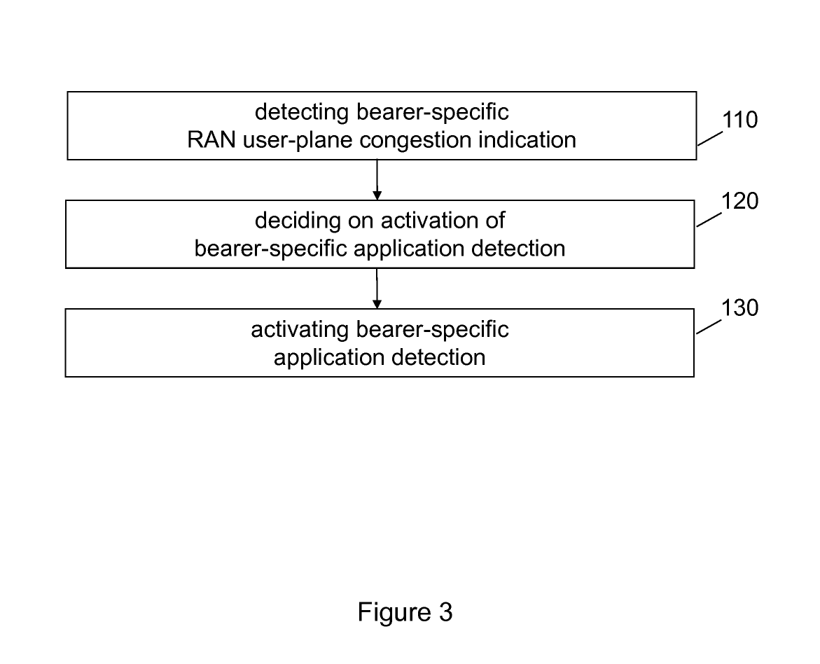

Hereinafter, various methods according to exemplary embodiments of the present invention are described with reference to FIGS. 3 to 6. Any one of these methods is operable at or by a core network, such as EPS CN, or element/entity thereof, such as PGW, HPLMN PGW and/or GGSN.

FIG. 3 shows a flowchart illustrating a first example of a method according to exemplary embodiments of the present invention.

As shown in FIG. 3, a method according to exemplary embodiments of the present invention comprises an operation (110) of detecting a congestion indication for at least one bearer, which indicates user-plane congestion for the at least one bearer in a radio access network, i.e. a RAN user-plane congestion indication, an operation (120) of deciding on activation of application detection for the at least one bearer on the basis of the detected congestion indication, and an operation (130) of activating application detection for the at least one bearer upon an activation decision.

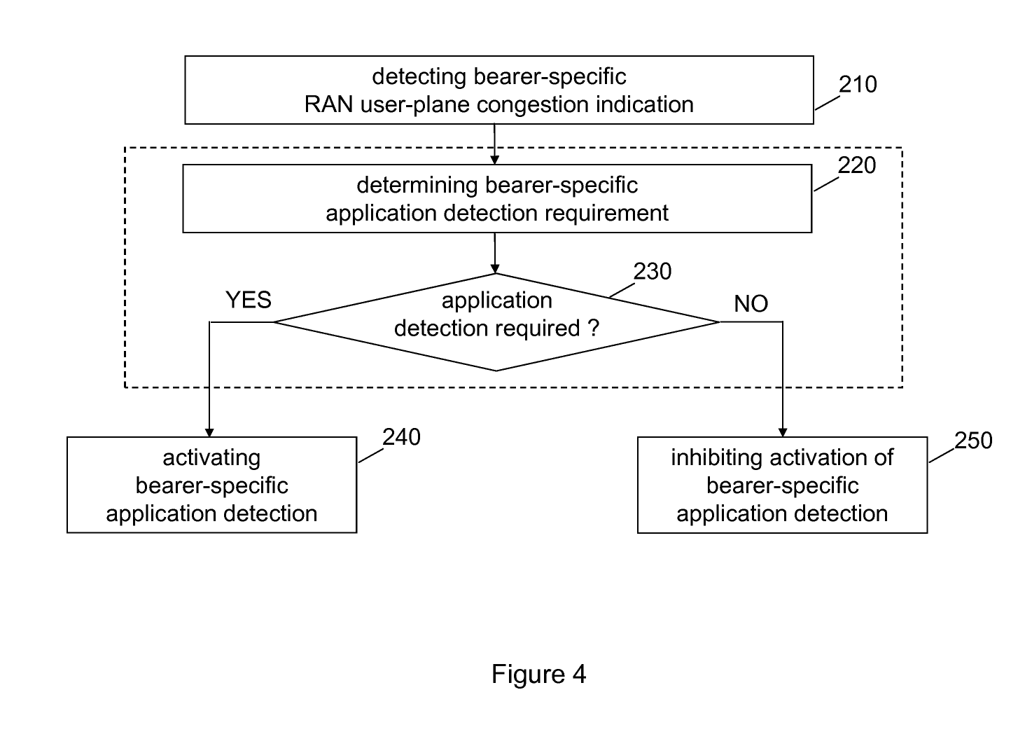

FIG. 4 shows a flowchart illustrating a second example of a method according to exemplary embodiments of the present invention.

In a method according to exemplary embodiments of the present invention, as shown in FIG. 4, the operation 210 corresponds to the operation 110 of FIG. 3, the dashed box (including operations 220 and 230) corresponds to the operation 120 of FIG. 3, and the operation 240 corresponds to the operation 130 of FIG. 3.

As shown in FIG. 4, a deciding operation according to exemplary embodiments of the present invention comprises an operation (220) of determining a requirement of application detection for the at least one bearer, and an operation (230) of making an activation decision on the basis of the previously detected congestion indication and the determined requirement of application detection for the at least one bearer in question. When it is determined that the at least one bearer requires application detection (YES in 230), the method proceeds to an operation (240) of activating an application detection for the at least one bearer. Otherwise, when it is determined that the at least one bearer does not require application detection (NO in 230), the method proceeds to an operation (250) of inhibiting activation of an application detection for the at least one bearer.

Accordingly, when a congestion indication is received/detected for a specific or multiple bearers (depending on the way how the congestion indication is delivered from the RAN to the CN), and this specific bearer requires or these multiple bearers require application detection, then the core network will immediately activate application detection and related functions (as outlined below), such as packet marking that may be required to control the treatment of specific applications or application flows in the RAN.

In the operation 220, the requirement of application detection for the at least one bearer may be determined either by local or remote configuration. For local determination, a QoS class identifier (QCI) or an access point name (APN) of the at least one bearer may be evaluated. For remote determination, a configuration for the at least one bearer may be inquired in a home location register (HLR), a home subscriber server (HSS) or an authentication, authorization and accounting (AAA) server.

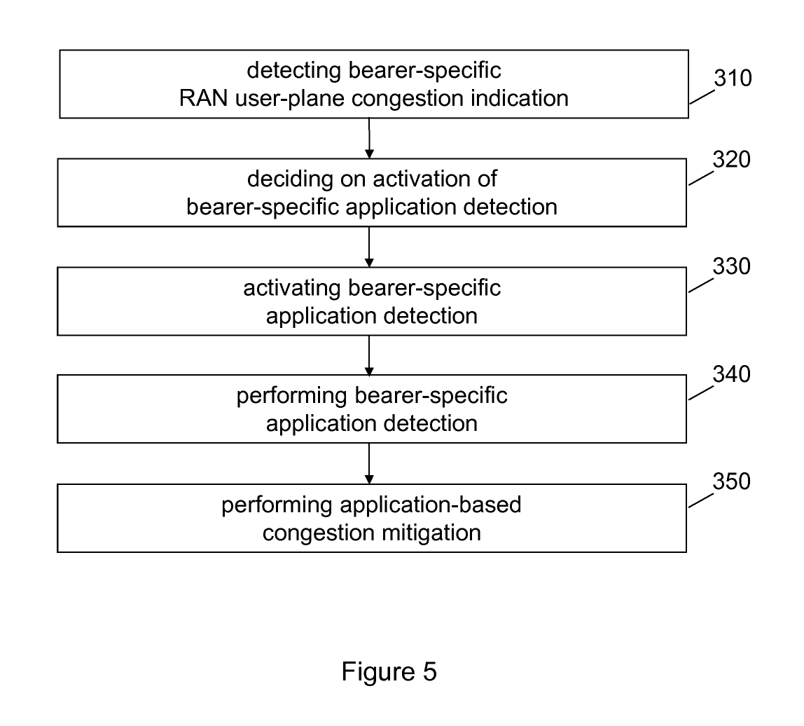

FIG. 5 shows a flowchart illustrating a third example of a method according to exemplary embodiments of the present invention.

In a method according to exemplary embodiments of the present invention, as shown in FIG. 5, the operations 310, 320 and 330 correspond to the operations 110, 120 and 130 of FIG. 3, respectively.

As shown in FIG. 5, a method according to exemplary embodiments of the present invention further comprises an operation (340) of performing the activated application detection for identifying at least one application or application flow for the at least one bearer, and an operation (350) of performing application-based congestion mitigation for the identified at least one application or application flow.

As indicated above, the application detection may comprise deep packet inspection (DPI) and supporting functions such as traffic classification and packet marking, and/or QoE monitoring. Also, the application-based congestion mitigation may comprise an assignment of a specified QoS/QoE (class) to the identified at least one application or application flow. Depending on the type of mitigation measure to be applied in the application-based congestion mitigation, QoS/QoE control/adjustment may be effected through traffic prioritization, traffic reduction or traffic limitation based on the congestion indication (possibly relevant congestion information such as severity level of congestion, etc.). Thereby, differentiated QoS/QoE on application/application flow basis may be achieved. In this regard, both in-bearer QoS/QoE solutions and bearer-based QoS/QoE solutions in the RAN may be appropriately managed/handled.

According to exemplary embodiments of the present invention, application detection and/or application-based congestion mitigation are applicable for any traffic passing the core network, i.e. traffic from RAN towards PDN and/or traffic from PDN towards RAN.

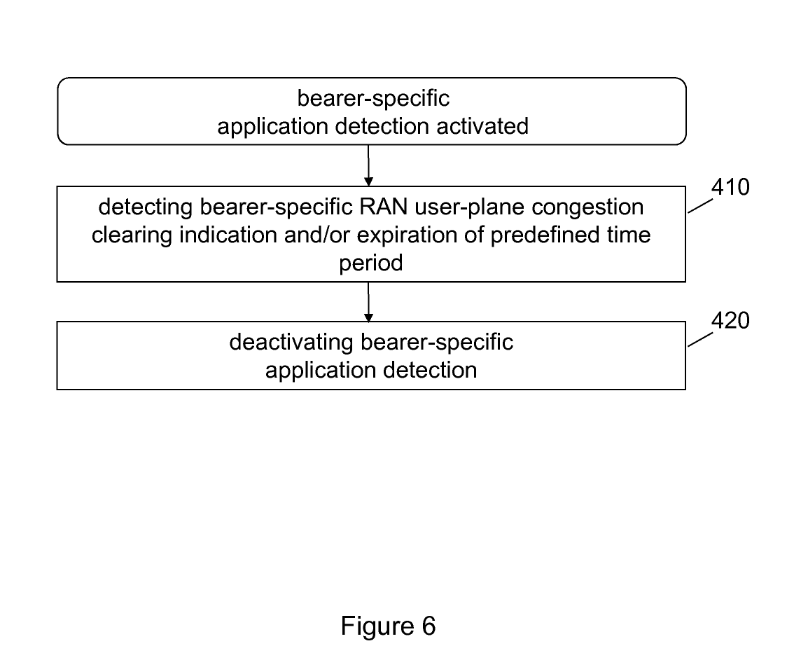

FIG. 6 shows a flowchart illustrating a fourth example of a method according to exemplary embodiments of the present invention.

As shown in FIG. 6, a method according to exemplary embodiments of the present invention presumes as a starting condition that an application detection is activated for at least one bearer in question (as a result of the third step of FIG. 2, the operation 130 of FIG. 3, the operation 240 of FIG. 4, or the operation 330 of FIG. 5). The thus shown method according to exemplary embodiments of the present invention comprises an operation (410) of detecting at least a congestion clearing indication for the at least one bearer, which indicates clearing of the user-plane congestion for the at least one bearer in the radio access network, and/or expiration of a predefined time period since detection of the congestion indication for the at least one bearer or activation of the application detection for the at least one bearer, and an operation (420) of deactivating the activated application detection for the at least one bearer.

Accordingly, application detection for at least one bearer may be deactivated when the congestion indication for the at least one bearer is cleared (e.g. the congestion is abated) explicitly by the RAN, or after a pre-defined timer (of a predefined time period) has expired (e.g. since detection of the recently cleared congestion indication or the resulting activation of application detection), or when the congestion indication for the at least one bearer is cleared (e.g. the congestion is abated) explicitly by the RAN and a pre-defined timer (of a predefined time period) has expired (e.g. since detection of the recently cleared congestion indication or the resulting activation of application detection).

As evident from the above, it is noted that, in FIGS. 3 to 6, the term “bearer-specific congestion indication” generally refers to a congestion indication for at least one bearer, and the term “bearer-specific application detection” generally refers to application detection for at least one bearer. That is, “bearer-specific congestion indication” and term “bearer-specific application detection” in FIGS. 3 to 6 relates to congestion indication and application detection with respect to a single bearer or multiple bearers (irrespective of the granularity of implementation), respectively.

By virtue of exemplary embodiments of the present invention, as evident from the above, management of user-plane congestion in a radio access network, i.e. RAN user-plane congestion management, can be improved/enhanced. Stated in different words, exemplary embodiments of the present invention proposes a solution for dynamic and bearer-selective activation and deactivation of application detection and, thus, enables a corresponding differentiation in RAN user-plane congestion mitigation, e.g. differentiated QoS/QoE, on an application/application flow basis.

Specifically, exemplary embodiments of the present invention teach to use congestion feedback (e.g. in the form of a congestion indication) from a radio access network as a trigger to activate user-plane traffic processing functions on a per-bearer basis in the core network, including e.g. bearer-specific application detection. The technique of RAN user-plane congestion management according to exemplary embodiments of the present invention is operable on a per-bearer basis (for downlink and/or uplink traffic), including per-bearer congestion feedback and per-bearer application detection, and is compatible with both in-bearer QoS/QoE solutions and bearer-based QoS/QoE solutions in the radio access network. Further, the technique of RAN user-plane congestion management according to exemplary embodiments of the present invention is independent from the specific technique/channel of transporting the congestion feedback (e.g. in the form of a congestion indication) from the radio access network to the core network, as long as the congestion feedback (e.g. in the form of a congestion indication) reaches the responsible gateway entity of the core network (e.g. PGW, HPLMN PGW, GGSN, TDF). Preferably, the congestion feedback (e.g. in the form of a congestion indication) should be transported so as to reach the responsible gateway entity of the core network as fast as possible to allow for a fast reaction in terms of RAN user-plane congestion management/mitigation in the core network.

Accordingly, exemplary embodiments of the present invention enable a more efficient RAN user-plane congestion management with application-based traffic management (in downlink and/or uplink), especially in situations of low overall traffic load and an associated low likelihood of the occurrence of RAN user-plane congestion. This can be achieved in that the technique of RAN user-plane congestion management according to exemplary embodiments of the present beneficially utilizes that, in the use case of RAN user-plane congestion management, differentiated treatment of applications or application flows is only expedient/required when there occurs some kind of congestion situation in a radio access network. Therefore, it is enabled to perform application detection only for a subset of bearers (or UEs) that experience congestion in the radio access network at a specific point in time.

By way of exemplary embodiments of the present invention, it is thus enabled to (possibly even significantly) reduce signaling and processing overhead in terms of RAN user-plane congestion management/mitigation in the core network in case of RAN user-plane congestion situations. In a well-designed network, only a small fraction of radio cells and bearers will experience congestion at any point in time, even during the busy hour. Periods of high traffic load are very sporadic, and often triggered by a single user of a radio cell. For example, if assuming that only 10% of the bearers experience congestion at the same time, a 90% reduction in DPI processing resources can be achieved as compared with conventional solutions (which presume that all traffic passing the core network is to be permanently detected all the time). Specifically, the savings potential depends on the traffic load of the network, and will increase when the overall traffic load is decreasing.

The above-described methods, procedures and functions may be implemented by respective functional elements, processors, or the like, as described below.

While in the foregoing exemplary embodiments of the present invention are described mainly with reference to methods, procedures and functions, corresponding exemplary embodiments of the present invention also cover respective apparatuses, network nodes and systems, including both software and/or hardware thereof.

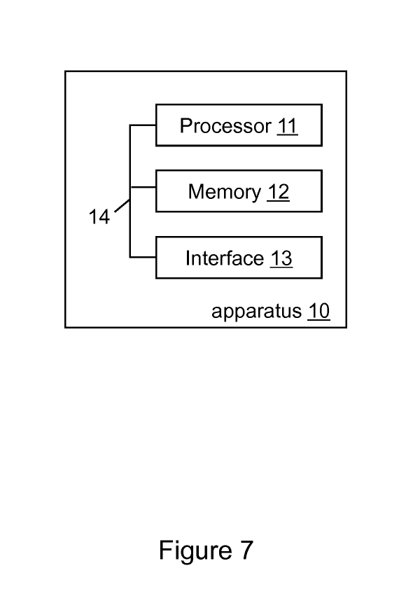

Respective exemplary embodiments of the present invention are described below referring to FIG. 7, while for the sake of brevity reference is made to the detailed description of respective corresponding configurations/setups, schemes, methods and functionality, principles and operations according to FIGS. 1 to 6.

FIG. 7 shows a schematic diagram illustrating an exemplary structure of apparatuses according to exemplary embodiments of the present invention.

In FIG. 7, the solid line blocks are basically configured to perform respective operations as described above. The entirety of solid line blocks are basically configured to perform the methods and operations as described above, respectively. With respect to FIG. 7, it is to be noted that the individual blocks are meant to illustrate respective functional blocks implementing a respective function, process or procedure, respectively. Such functional blocks are implementation-independent, i.e. may be implemented by means of any kind of hardware or software, respectively. The lines interconnecting individual blocks are meant to illustrate an operational coupling there-between, which may be a physical and/or logical coupling, which on the one hand is implementation-independent (e.g. wired or wireless) and on the other hand may also comprise an arbitrary number of intermediary functional entities not shown.

Further, in FIG. 7, only those functional blocks are illustrated, which relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

As indicated in FIG. 7, according to exemplary embodiments of the present invention, the apparatus 10 may comprise at least one processor 11 and at least one memory 12 (and possibly also at least one interface 13), which may be connected by a bus 14 or the like, respectively.

The processor 11 and/or the interface 13 of the apparatus 10 may also include a modem or the like to facilitate communication over a (hardwire or wireless) link, respectively. The interface 13 of the apparatus 10 may include a suitable transceiver coupled to one or more antennas or communication means for (hardwire or wireless) communications with the linked or connected device(s), respectively. The interface 13 of the apparatus 10 is generally configured to communicate with at least one other apparatus.

The memory 12 of the apparatus 10 may store respective programs assumed to include program instructions or computer program code that, when executed by the respective processor, enables the respective electronic device or apparatus to operate in accordance with the exemplary embodiments of the present invention. For example, the memory 12 of the apparatus 10 may store a bearer configuration e.g. per QCI/APN, or the like.

In general terms, respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

In view of the above, the thus illustrated apparatus 10 is suitable for use in practicing the exemplary embodiments of the present invention, as described herein.

The thus illustrated apparatus 10 may represent a (part of a) gateway entity of/for a core network, such as a PGW, HPLMN PGW, GGSN, TDF, or the like, according to exemplary embodiments of the present invention, and it may be configured to perform a procedure and/or exhibit a functionality as described (for the core network) in any one of FIGS. 2 to 6.

When in the subsequent description it is stated that the processor (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “processor configured to [cause the apparatus to] perform xxx-ing” is construed to be equivalent to an expression such as “means for xxx-ing”).

In its most basic form, according to exemplary embodiments of the present invention, the apparatus 10 or its processor 11 (possibly together with computer program code stored in the memory 12) is configured to perform detecting a congestion indication for at least one bearer, which indicates user-plane congestion for the at least one bearer in a radio access network, deciding on activation of application detection for the at least one bearer on the basis of the detected congestion indication, and activating application detection for the at least one bearer upon an activation decision.

Accordingly, stated in other words, the apparatus 10 at least comprises respective means for detecting a congestion indication, means for deciding on activation of application detection, and means for activating application detection.

According to various modifications and/or developments, the apparatus 10 or its processor 11 (possibly together with computer program code stored in the memory 12) is configured to perform, or—stated differently—comprises means for
performing the activated application detection for identifying at least one application or application flow for the at least one bearer, and performing application-based congestion mitigation for the identified at least one application or application flow, and/or
executing deep packet inspection and supporting functions such as traffic classification and packet marking, and/or quality-of-experience monitoring, and/or
executing assignment of a specified quality-of-service and/or quality-of-experience to the identified at least one application or application flow, and/or
detecting at least a congestion clearing indication for the at least one bearer, which indicates clearing of the user-plane congestion for the at least one bearer in the radio access network, and expiration of a predefined time period since detection of the congestion indication for the at least one bearer or activation of the application detection for the at least one bearer, and deactivating the activated application detection for the at least one bearer, and/or
determining a requirement of application detection for the at least one bearer, and making an activation decision for the at least one bearer when it is determined that the at least one bearer requires application detection, and/or
evaluating a quality-of-service class identifier or an access point name of the at least one bearer, and/or
inquiring a configuration for the at least one bearer in one of a home location register, a home subscriber server and an authentication, authorization and accounting server.

Similarly, the thus illustrated apparatus 10 may represent a (part of a) network entity of/for a radio access network, such as BSC, RNC, eNB, or the like, according to exemplary embodiments of the present invention, and it may be configured to perform a procedure and/or exhibit a functionality as described (for the radio access network) in FIG. 2.

For further details regarding the operability/functionality of the individual apparatuses, reference is made to the above description in connection with any one of FIGS. 1 to 6, respectively.

According to exemplarily embodiments of the present invention, any one of the processor, the memory and the interface may be implemented as individual modules, chips, chipsets, circuitries or the like, or one or more of them can be implemented as a common module, chip, chipset, circuitry or the like, respectively.

According to exemplarily embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for improving/enhancing RAN user-plane congestion management. Such measures exemplarily comprise detecting a congestion indication for at least one bearer, which indicates user-plane congestion for the at least one bearer in a radio access network, deciding on activation of application detection for the at least one bearer on the basis of the detected congestion indication, and activating application detection for the at least one bearer upon an activation decision.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

### 3GPP 3^{rd} Generation Partnership Project

### AAA Authentication, Authorization and Accounting

### ADC Application Detection and Control

### APN Access Point Name

### BSC Base Station Controller

### CN Core Network

### DPI Deep Packet Inspection

EDGE Enhanced Data rates for Global Evolution

### E-UTRAN Evolved UTRAN

eNB enhanced NodeB

### EPS Evolved Packet System

### GERAN GSM/EDGE Radio Access Network

### GGSN Gateway GPRS Support Node

### GPRS General Packet Radio Service

### GSM Global System for Mobile Communication

### GTP-U GPRS Tunneling Protocol User Plane

### HLR Home Location Register

### HPLMN Home Public Land Mobile Network

### HSS Home Subscriber Server

### IP Internet Protocol

### IP-CAN IP Connectivity Access Network

### LTE Long Term Evolution

### LTE-A Long Term Evolution Advanced

### MME Mobility Management Entity

### PCC Policy and Charging Control

### PCEF Policy and Charging Enforcement Function

PCRF Policy and Charging Rules function

### PGW Packet Data Network Gateway

### PDN Packet Data Network

### QCI QoS Class Identifier

### QoE Quality of Experience

### QoS Quality of Service

### RAN Radio Access Network

### RNC Radio Network Controller

### SGW Serving Gateway

### TDF Traffic Detection Function

### UE User Equipment

### UMTS Universal Mobile Telecommunications System

### UPCON User Plane Congestion Management

### UTRAN UMTS Terrestrial Radio Access Network

1. A method comprising
detecting a congestion indication for at least one bearer, which indicates user-plane congestion for the at least one bearer in a radio access network,
deciding on activation of application detection for the at least one bearer on the basis of the detected congestion indication, and
activating application detection for the at least one bearer upon an activation decision.

2. The method according to claim 1, further comprising
performing the activated application detection for identifying at least one application or application flow for the at least one bearer, and
performing application-based congestion mitigation for the identified at least one application or application flow.

3. The method according to claim 2, wherein
the application detection comprises deep packet inspection and supporting functions such as traffic classification and packet marking, or quality-of-experience monitoring, or
the application-based congestion mitigation comprises assignment of a specified quality-of-service or quality-of-experience to the identified at least one application or application flow.

4. The method according to claim 1, further comprising
detecting at least a congestion clearing indication for the at least one bearer, which indicates clearing of the user-plane congestion for the at least one bearer in the radio access network, and expiration of a predefined time period since detection of the congestion indication for the at least one bearer or activation of the application detection for the at least one bearer, and
deactivating the activated application detection for the at least one bearer.

5. The method according to claim 1, wherein the deciding comprises
determining a requirement of application detection for the at least one bearer, and
making an activation decision for the at least one bearer when it is determined that the at least one bearer requires application detection.

6. The method according to claim 5, wherein the requirement of application detection for the at least one bearer is determined on the basis of
evaluating a quality-of-service class identifier or an access point name of the at least one bearer, or
inquiring a configuration for the at least one bearer in one of a home location register, a home subscriber server, a policy server and an authentication, authorization and accounting server.

7. The method according to claim 1, wherein
the method is operable in or by a policy and charging enforcement function or a traffic detection function, or
the method is operable in an evolved packet system.

8. The method according to claim 1, wherein
the method is operable at or by a gateway entity of a core network, such as a packet data network gateway and a gateway support node, or
the method is operable at or by a standalone traffic detection function entity of a core network.

9. An apparatus comprising
an interface configured to communicate with at least another apparatus,
a memory configured to store computer program code, and
a processor configured to cause the apparatus to perform:
detecting a congestion indication for at least one bearer, which indicates user-plane congestion for the at least one bearer in a radio access network,
deciding on activation of application detection for the at least one bearer on the basis of the detected congestion indication, and
activating application detection for the at least one bearer upon an activation decision.

10. The apparatus according to claim 9, wherein the processor is configured to cause the apparatus to perform:
performing the activated application detection for identifying at least one application or application flow for the at least one bearer, and
performing application-based congestion mitigation for the identified at least one application or application flow.

11. The apparatus according to claim 10, wherein
the application detection comprises deep packet inspection and supporting functions such as traffic classification and packet marking, or quality-of-experience monitoring, or
the application-based congestion mitigation comprises assignment of a specified quality-of-service or quality-of-experience to the identified at least one application or application flow.

12. The apparatus according to claim 9, wherein the processor is configured to cause the apparatus to perform:
detecting at least a congestion clearing indication for the at least one bearer, which indicates clearing of the user-plane congestion for the at least one bearer in the radio access network, and expiration of a predefined time period since detection of the congestion indication for the at least one bearer or activation of the application detection for the at least one bearer, and
deactivating the activated application detection for the at least one bearer.

13. The apparatus according to claim 9, wherein the processor is configured to cause the apparatus to perform in deciding:
determining a requirement of application detection for the at least one bearer, and
making an activation decision for the at least one bearer when it is determined that the at least one bearer requires application detection.

14. The apparatus according to claim 13, wherein the processor is configured to cause the apparatus to determine the requirement of application detection for the at least one bearer on the basis of
evaluating a quality-of-service class identifier or an access point name of the at least one bearer, or
inquiring a configuration for the at least one bearer in one of a home location register, a home subscriber server, a policy server and an authentication, authorization and accounting server.

15. The apparatus according to claim 9, wherein
the apparatus is operable in or as or by a policy and charging enforcement function or a traffic detection function, or
the apparatus is operable in an evolved packet system.

16. The apparatus according to claim 9, wherein
the apparatus is operable in or as or by a gateway entity of a core network, such as a packet data network gateway and a gateway support node, or
the apparatus is operable in or as or by a standalone traffic detection function entity of a core network.

17. An apparatus comprising
means for detecting a congestion indication for at least one bearer, which indicates user-plane congestion for the at least one bearer in a radio access network,
means for deciding on activation of application detection for the at least one bearer on the basis of the detected congestion indication, and
means for activating application detection for the at least one bearer upon an activation decision.

18. A computer program product embodied on a non-transitory computer-readable medium, said product comprising computer-executable computer program code which, when the computer program code is executed on a computer, is configured to cause the computer to carry out the method according to claim 1.

19. (canceled)
